(19) United States
(12) Patent Application Publication
(10) Pub. No.: US 2022/0127738 A1
(43) Pub. Date: Apr. 28, 2022

(54) ELECTROLYTE MANUFACTURING DEVICE AND METHOD FOR MANUFACTURING ELECTROLYTE

(71) Applicant: LE System Co., LTD., Kurume-shi, Fukuoka (JP)

(72) Inventor: Yukio MATSUMURA, Tsukuba-shi, Ibaraki (JP)

(73) Assignee: LE System Co., LTD., Kurume-shi, Fukuoka (JP)

(21) Appl. No.: 17/427,718

(22) PCT Filed: Jan. 31, 2020
(86) PCT No.: PCT/JP2020/003807

§ 371 Date: Aug. 2, 2021

(30) Foreign Application Priority Data
Feb. 5, 2019 (JP) 2019-018747

(51) Int. Cl. C25B 15/08; C25C 1/22; H01M 8/18; H01M 8/06; H01M 8/04791; H01M 8/04746; C25B 9/19

(52) U.S. Cl. CPC C25B 15/08; C25C 1/22; H01M 8/188; C25B 9/19; H01M 8/04791; H01M 8/04746; H01M 8/06

(57) ABSTRACT

An electrolyte manufacturing device includes an electrolytic cell including a diaphragm separating an anode chamber from a cathode chamber, a circulator circulating an anolyte to the anode chamber and circulating a catholyte to the cathode chamber, and a power source supplying current. A cathode in the electrolytic cell includes a carbon fiber layer on a plane facing the diaphragm. The electrolytic cell includes an anode net placed between the anode and the diaphragm, and a cathode net placed between the cathode and the diaphragm. The circulator circulates the anolyte at a flow rate that is greater than the flow rate of the catholyte and is equal to or greater than twice the volume of gaseous oxygen generated in the anode chamber per unit time at 0° C.

### TECHNICAL FIELD

The present disclosure relates to an electrolyte manufacturing device and a method for manufacturing an electrolyte.

### BACKGROUND ART

A redox-flow battery is known as a high-capacity storage battery. The redox-flow battery performs charge-discharge by supplying a positive electrode electrolyte and a negative electrode electrolyte to a battery cell in which an ion exchange membrane is provided between a positive electrode and a negative electrode. A solution containing metal a valence of which varies by an oxidation-reduction reaction is used as a positive electrode electrolyte and a negative electrode electrolyte. An electrolyte containing vanadium is widely used as a positive electrode electrolyte and a negative electrode electrolyte of the redox-flow battery. The electrolyte containing vanadium is manufactured from ammonium metavanadate (NH₄VO₃), vanadium pentoxide (V₂O₅), vanadyl sulfate (VO₅O₄), or the like.

For example, Patent Literature 1 discloses an electrolyte manufacturing device manufacturing an electrolyte containing a trivalent vanadium ion by using a sulfuric acid solution containing a vanadyl sulfate as a catholyte and a sulfuric acid solution as an anolyte and generating an oxidation-reduction reaction. Specifically, the electrolyte manufacturing device in Patent Literature 1 includes an ion exchange membrane separating the anolyte from the catholyte, an anode placed at a position separate from the ion exchange membrane by 1 mm or greater, and a power source mechanism supplying current in such a way that current density in the catholyte near a cathode is equal to or greater than 50 mA/cm² and equal to or less than 600 mA/cm² during an oxidation-reduction reaction. The electrolyte manufacturing device in Patent Literature 1 further includes a cathode-side circulation mechanism circulating the electrolyte in such a way that the flow speed of the catholyte near the cathode per unit area of the cathode is equal to or greater than 0.1 mL/min·cm² and equal to or less than 2.5 mL/min·cm² and an anode-side circulation mechanism circulating the anolyte in such as way that the flow speed of the anolyte near the anode is equal to or greater than 0.1 mL/min·cm² and equal to or less than 2.5 mL/min·cm².

### CITATION LIST

### Patent Literature

Patent Literature 1: Japanese Patent No. 5779292

### SUMMARY OF INVENTION

### Technical Problem

The electrolyte manufacturing device in Patent Literature 1 has high cell resistance and low energy efficiency. Further, the device has a high heating value, and therefore a large cooling device for cooling the electrolyte manufacturing device is required, and equipment costs increase.

The present disclosure has been made in view of the aforementioned circumstances, and an objective thereof is to provide an electrolyte manufacturing device and a method for manufacturing an electrolyte that enable low cell resistance, high current efficiency in reduction, and low pressure loss in circulation of an electrolyte.

### Solution to Problem

In order to achieve the aforementioned objective, an electrolyte manufacturing device according to a first aspect of the present disclosure includes:

an electrolytic cell including an anode chamber in which an anode is placed, a cathode chamber in which a cathode is placed, and a diaphragm separating the anode chamber from the cathode chamber;

a circulator circulating an aqueous sulfuric acid solution as an anolyte to the anode chamber and circulating an aqueous sulfuric acid solution containing quadrivalent or higher polyvalent vanadium as a catholyte to the cathode chamber; and

a power source being electrically connected to the anode and the cathode and supplying current, wherein

the cathode includes a carbon fiber layer on a plane facing the diaphragm,

the electrolytic cell includes a mesh-like anode net placed between the anode and the diaphragm, and a mesh-like cathode net placed between the cathode and the diaphragm, and

the circulator circulates the anolyte at a flow rate that is greater than a flow rate of the catholyte and is equal to or greater than twice a volume of gaseous oxygen generated in the anode chamber per unit time at 0° C.

A method for manufacturing an electrolyte according to a second aspect of the present disclosure includes:

a circulation process of circulating an aqueous sulfuric acid solution as an anolyte to an anode chamber separated by a diaphragm, an anode and a mesh-like anode net placed between the anode and the diaphragm being placed in the anode chamber, and circulating an aqueous sulfuric acid solution containing quadrivalent or higher polyvalent vanadium as a catholyte to a cathode chamber separated by the diaphragm, a cathode including a carbon fiber layer on a plane facing the diaphragm, and a mesh-like cathode net placed between the cathode and the diaphragm being placed in the cathode chamber; and

a reduction process of supplying current between the anode and the cathode and electrolytically reducing the quadrivalent or higher polyvalent vanadium in the cathode chamber,

wherein, in the circulation process, the anolyte is circulated at a flow rate that is greater than a flow rate of the catholyte and is equal to or greater than twice a volume of gaseous oxygen generated in the anode chamber per unit time at 0° C.

### Advantageous Effects of Invention

The present disclosure can provide an electrolyte manufacturing device and a method for manufacturing an electrolyte that enable low cell resistance, high current efficiency in reduction, and low pressure loss in circulation of an electrolyte.

### BRIEF DESCRIPTION OF DRAWINGS

FIG. 1 is a schematic diagram illustrating an electrolyte manufacturing device according to an embodiment of the present disclosure;

FIG. 2 is a cross-sectional view of an electrolytic cell according to the embodiment of the present disclosure;

FIG. 3 is a schematic diagram illustrating a mesh of an anode net according to the embodiment of the present disclosure;

FIG. 4 is a schematic diagram illustrating a mesh of a cathode net according to the embodiment of the present disclosure;

FIG. 5 is a flowchart illustrating a method for manufacturing an electrolyte according to the embodiment of the present disclosure; and

FIG. 6 is a diagram illustrating measurement results of examples and comparative examples.

### DESCRIPTION OF EMBODIMENTS

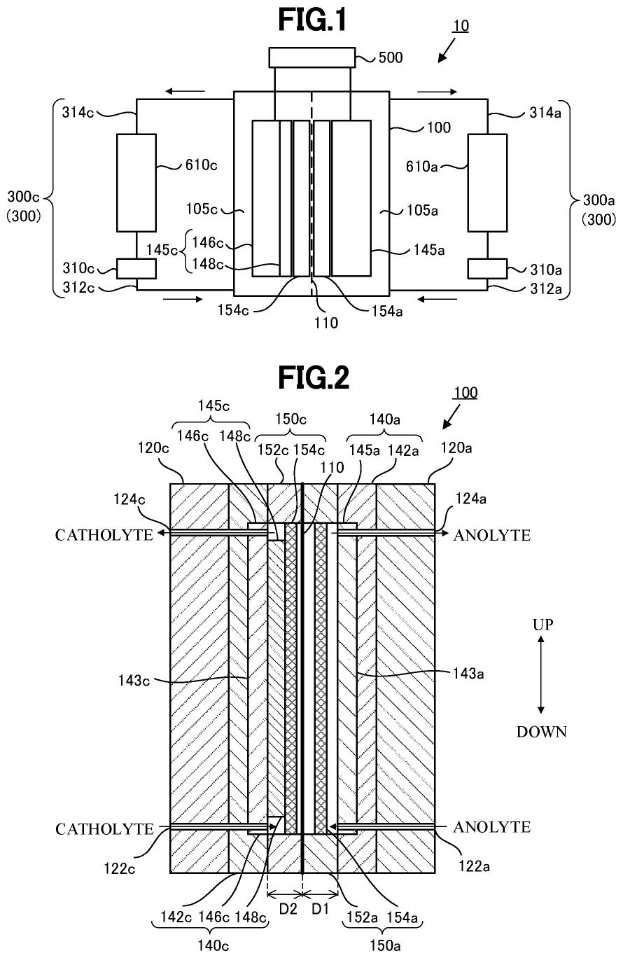

An electrolyte manufacturing device 10 according to an embodiment of the present disclosure will be described with reference to FIG. 1 to FIG. 4.

The electrolyte manufacturing device 10 circulates an aqueous sulfuric acid solution as an anolyte to an anode chamber 105a and circulates an aqueous sulfuric acid solution containing quadrivalent or higher polyvalent vanadium as a catholyte to a cathode chamber 105c. The electrolyte manufacturing device 10 manufactures an electrolyte containing trivalent vanadium by electrolytically reducing quadrivalent or higher polyvalent vanadium. For example, the concentration of quadrivalent or higher polyvalent vanadium in the aqueous sulfuric acid solution containing quadrivalent or higher polyvalent vanadium is equal to or greater than 1.0 mol/L and equal to or less than 3.0 mol/L, according to the present embodiment. Further, it is preferable that the aqueous sulfuric acid solution as the anolyte have the osmol concentration equal to or greater than the osmol concentration of the catholyte. Quinquevalent vanadium herein means a vanadium compound ion a vanadium valence of which is a quinquevalence [such as a metavanadate ion (VO₃⁻) or a pervanadyl ion (VO₂⁺)] or a vanadium ion. Quadrivalent vanadium means a vanadium compound ion a vanadium valence of which is a quadrivalence [such as a vanadyl ion (VO²⁺)] or a vanadium ion. Trivalent vanadium means a vanadium compound ion a vanadium valence of which is a trivalence or a vanadium ion.

As illustrated in FIG. 1, the electrolyte manufacturing device 10 includes an electrolytic cell 100 including an anode chamber 105a and a cathode chamber 105c separated by a diaphragm 110, and a circulator 300 including an anolyte circulator 300a circulating an anolyte to the anode chamber 105a and a catholyte circulator 300c circulating a catholyte to the cathode chamber 105c. Further, the electrolyte manufacturing device 10 includes a power source 500 supplying current for generating a reduction reaction in the cathode chamber 105c. The electrolyte manufacturing device 10 further includes an anolyte storage tank 610a storing the anolyte and a catholyte storage tank 610c storing the catholyte.

Further, the electrolytic cell 100 includes an anode 145a placed in the anode chamber 105a and a cathode 145c being placed in the cathode chamber 105c and including a carbon fiber layer 148c on a plane facing the diaphragm 110. The electrolytic cell 100 further includes an anode net 154a placed between the anode 145a and the diaphragm 110, and a cathode net 154c placed between the cathode 145c and the diaphragm 110.

The anolyte circulator 300a in the circulator 300 includes an anode pump 310a circulating the anolyte between the anode chamber 105a and the anolyte storage tank 610a, an anolyte supply pipe 312a supplying the anolyte to the anode chamber 105a, and an anolyte recovery pipe 314a recovering the anolyte from the anode chamber 105a. The catholyte circulator 300c in the circulator 300 includes a cathode pump 310c circulating the catholyte between the cathode chamber 105c and the catholyte storage tank 610c, a catholyte supply pipe 312c supplying the catholyte to the cathode chamber 105c, and a catholyte recovery pipe 314c recovering the catholyte from the cathode chamber 105c.

First, a specific structure of the electrolytic cell 100 will be described. As illustrated in FIG. 2, the electrolytic cell 100 is constituted by laminating an anode frame body 120a, an anode part 140a including the anode 145a, an anode net part 150a including the anode net 154a, the diaphragm 110, a cathode net part 150c including the cathode net 154c, a cathode part 140c including the cathode 145c, and a cathode frame body 120c in this order. For ease of understanding, the upper side of the page in FIG. 2 is determined to be an upper side, and the lower side of the page is determined to be a lower side in the following description.

The anode frame body 120a in the electrolytic cell 100 constitutes an external form of the electrolytic cell 100. Along with the cathode frame body 120c, the anode frame body 120a sandwiches the anode part 140a, the anode net part 150a, the diaphragm 110, the cathode net part 150c, and the cathode part 140c. The anode frame body 120a is formed from synthetic resin (such as polyvinyl chloride) into a flat plate shape.

The anode frame body 120a includes, at the lower end thereof, a channel (unillustrated) including an inlet 122a connected to the anolyte supply pipe 312a in the anolyte circulator 300a and a plurality of outlets (unillustrated). Further, the anode frame body 120a includes, at the upper end thereof, a channel (unillustrated) including an outlet 124a connected to the anolyte recovery pipe 314a in the anolyte circulator 300a and a plurality of inlets (unillustrated). The lower channel in the anode frame body 120a is connected to a plurality of through-holes (unillustrated) on the lower side of the anode part 140a and forms a manifold for supplying the anolyte to the anode chamber 105a. The upper channel in the anode frame body 120a is connected to a plurality of through-holes (unillustrated) on the upper side of the anode part 140a and forms a manifold for recovering the anolyte from the anode chamber 105a.

The anode part 140a in the electrolytic cell 100 includes an anode base plate 142a and the anode 145a. For example, the anode base plate 142a is formed from a thermoplastic elastomer, synthetic rubber, or polyvinyl chloride into a plate shape including a recessed part 143a. The anode base plate 142a, a frame part 152a of the anode net part 150a, and the diaphragm 110 form the anode chamber 105a, according to the present embodiment. The anode 145a is fitted into the recessed part 143a of the anode part 140a. For example, the anode 145a is a platinum-coated electrode being formed from titanium (Ti) into a plate shape and being coated with platinum (Pt). The anode 145a is flush-fitted into the recessed part 143a of the anode base plate 142a. The anode 145a is electrically connected to the power source 500. At the anode 145a, an electron is taken into the anode 145a from an ion contained in the anolyte (aqueous sulfuric acid solution), and oxygen is generated. In order to easily discharge the oxygen generated at the anode 145a, it is preferable that an interval D1 between the anode 145a and the diaphragm 110 be equal to or greater than 2 mm and equal to or less than 5 mm. As will be described later, the interval D1 between the anode 145a and the diaphragm 110 is secured by the anode net 154a.

A plurality of through-holes penetrating the anode base plate 142a and the anode 145a is provided at the lower end of the anode part 140a. The through-holes are connected to the lower channel in the anode frame body 120a. Further, a plurality of through-holes penetrating the anode base plate 142a and the anode 145a is provided at the upper end of the anode part 140a. The through-holes are connected to the upper channel in the anode frame body 120a.

The anode net part 150a includes the frame part 152a and the mesh-like anode net 154a. The frame part 152a is formed from synthetic resin (such as polypropylene) into a frame shape. The frame part 152a of the anode net part 150a supports the anode net 154a. Further, the frame part 152a forms the anode chamber 105a along with the anode base plate 142a and the diaphragm 110.

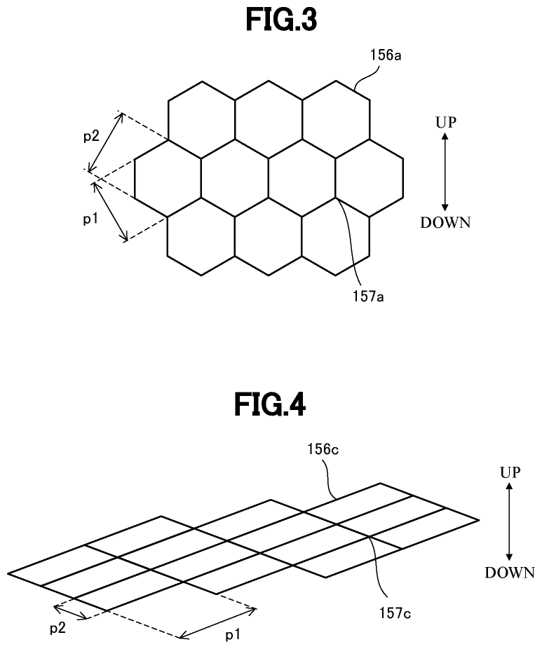

The anode net 154a in the anode net part 150a is a mesh-like net including a mesh. The anode net 154a is placed between the anode 145a and the diaphragm 110. The anode net 154a secures the interval D1 between the anode 145a and the diaphragm 110. Since the anode net 154a secures the interval D1 between the anode 145a and the diaphragm 110, oxygen generated in the anode chamber 105a can be easily discharged, and cell resistance can be decreased, according to the present embodiment. In order to easily discharge oxygen generated in the anode chamber 105a, it is desirable that the anode net 154a have a thickness of 50% to 150% of the interval D1 between the anode 145a and the diaphragm 110. For example, a hexagonal-mesh-like polyethylene net having lattice pitches: p1=p2=4.5 mm, a diameter of a thread 156a: 0.9 mm, and a thickness of the thread 156a at an intersection 157a: 1.7 mm as illustrated in FIG. 3 may be used as the anode net 154a.

Returning to FIG. 2, the diaphragm 110 in the electrolytic cell 100 is an ion exchange membrane. The diaphragm 110 separates the anode chamber 105a from the cathode chamber 105c and causes a predetermined ion to permeate. It is preferable that the thickness of the diaphragm 110 be equal to or greater than 100 μm from viewpoints of an amount of movement of water from the anode chamber 105a to the cathode chamber 105c, reduction in movement loss of a vanadium compound ion from the cathode chamber 105c to the anode chamber 105a, and the like.

The cathode frame body 120c in the electrolytic cell 100 constitutes an external form of the electrolytic cell 100, similarly to the anode frame body 120a. Along with the anode frame body 120a, the cathode frame body 120c sandwiches the anode part 140a, the anode net part 150a, the diaphragm 110, the cathode net part 150c, and the cathode part 140c. The cathode frame body 120c is formed from synthetic resin (such as polyvinyl chloride) into a flat plate shape, similarly to the anode frame body 120a.

The cathode frame body 120c includes, at the lower end thereof, a channel (unillustrated) including an inlet 122c connected to the catholyte supply pipe 312c in the catholyte circulator 300c and a plurality of outlets (unillustrated). Further, the cathode frame body 120c includes, at the upper end thereof, a channel (unillustrated) including an outlet 124c connected to the catholyte recovery pipe 314c in the catholyte circulator 300c and a plurality of inlets (unillustrated). The lower channel is connected to a plurality of through-holes (unillustrated) on the lower side of the cathode part 140c and forms a manifold for supplying the catholyte to the cathode chamber 105c. The upper channel is connected to a plurality of through-holes (unillustrated) on the upper side of the cathode part 140c and forms a manifold for recovering the catholyte from the cathode chamber 105c.

The cathode part 140c in the electrolytic cell 100 includes a cathode base plate 142c, a base cathode 146c, and the carbon fiber layer 148c. The base cathode 146c and the carbon fiber layer 148c constitute the cathode 145c. At the cathode 145c, quadrivalent or higher polyvalent vanadium contained in the catholyte (an aqueous sulfuric acid solution containing quadrivalent or higher polyvalent vanadium) is electrolytically reduced, and trivalent vanadium is generated.

The cathode base plate 142c in the cathode part 140c is formed from a thermoplastic elastomer, synthetic rubber, polyvinyl chloride, and the like into a plate shape including a recessed part 143c, similarly to the anode base plate 142a. The cathode base plate 142c, a frame part 152c of the cathode net part 150c, and the diaphragm 110 form the cathode chamber 105c, according to the present embodiment. The base cathode 146c is fitted into the recessed part 143a of the cathode base plate 142c.

For example, the base cathode 146c in the cathode part 140c is formed from lead (Pb) or a lead alloy into a plate shape. The base cathode 146c is flush-fitted into the recessed part 143c of the cathode base plate 142c. The base cathode 146c is electrically connected to the power source 500.

The carbon fiber layer 148c in the cathode part 140c is a layer acquired by processing carbon fiber into a non-woven shape, a felt-like shape, a woven shape, a sheet shape, or the like and is, for example, carbon felt. The carbon fiber layer 148c is provided on the base cathode 146c in close contact with each other and faces the diaphragm 110. Then, the catholyte flows inside the carbon fiber layer 148c. By the catholyte flowing inside the carbon fiber layer 148c, a side reaction generating hydrogen can be suppressed, and current efficiency in reduction (hereinafter described as reduction current efficiency) can be increased. In order to cause the catholyte to sufficiently flow into the carbon fiber layer 148c, it is preferable that an interval D2 between the diaphragm 110 and the base cathode 146c, and the thickness of the carbon fiber layer 148c before being incorporated into the electrolytic cell 100 be adjusted in such a way that a filling factor of the carbon fiber layer 148c is equal to or greater than 70% and equal to or less than 120%, according to the present embodiment. The filling factor of the carbon fiber layer 148c refers to the ratio of the thickness of the carbon fiber layer 148c before being incorporated into the electrolytic cell 100 to the interval D2 between the diaphragm 110 and the base cathode 146c.

Further, a plurality of through-holes constituting a manifold for supplying the catholyte to the cathode chamber 105c is provided in the cathode part 140c below the carbon fiber layer 148c. Further, a plurality of through-holes constituting a manifold for recovering the catholyte from the cathode chamber 105c is provided above the carbon fiber layer 148c. The through-holes facilitate the catholyte flowing into the carbon fiber layer 148c.

The cathode net part 150c in the electrolytic cell 100 includes the frame part 152c and the mesh-like cathode net 154c. The frame part 152c is formed from synthetic resin (such as polypropylene) into a frame shape, similarly to the frame part 152a of the anode net part 150a. The frame part 152c of the cathode net part 150c supports the cathode net 154c. The frame part 152c forms the cathode chamber 105c along with the cathode base plate 142c and the diaphragm 110.

The cathode net 154c in the cathode net part 150c is a mesh-like net including a mesh, similarly to the anode net 154a. The cathode net 154c is placed between the carbon fiber layer 148c in the cathode part 140c and the diaphragm 110. The cathode net 154c secures a gap (interval) between the carbon fiber layer 148c and the diaphragm 110. Thus, the catholyte flows inside the carbon fiber layer 148c in the cathode part 140c and through the gap secured by the cathode net 154c between the carbon fiber layer 148c and the diaphragm 110. By the catholyte flowing through the gap secured by the cathode net 154c between the carbon fiber layer 148c and the diaphragm 110, pressure loss in circulation of the catholyte can be decreased while the reduction current efficiency is being increased.

In order to decrease pressure loss in circulation of the catholyte while maintaining high reduction current efficiency by the carbon fiber layer 148c, it is preferable that the cathode net 154c be a thin net (such as a thickness of 0.4 mm to 1.0 mm) with a large mesh. Specifically, it is preferable that the cathode net 154c be a net having a lattice pitch greater than that of the anode net 154a and having a small thickness at an intersection of threads. For example, a deformed-rhombic-mesh-like polyethylene net having lattice pitches: p1=7.0 mm and p2=2.9 mm, a diameter of the thread 156c: 0.25 mm, and a thickness of the thread 156c at an intersection 157c: 0.63 mm as illustrated in FIG. 4 may be used as the cathode net 154c.

Next, the circulator 300 in the electrolyte manufacturing device 10 will be described. As illustrated in FIG. 1, the circulator 300 includes the anolyte circulator 300a and the catholyte circulator 300c.

The anolyte circulator 300a in the circulator 300 circulates the anolyte to the anode chamber 105a. The anolyte circulator 300a circulates the anolyte in such a way that a bubble fraction (bubble fraction: a ratio of the volume of gaseous oxygen generated in the anode chamber 105a to an amount of the anolyte supplied to the anode chamber 105a) in the anode chamber 105a at 0° C. and 1 atm is equal to or less than 50%. In other words, the anolyte circulator 300a circulates the anolyte at a flow rate equal to or greater than twice the volume of gaseous oxygen generated in the anode chamber per unit time at 0° C. and 1 atm. Thus, a rise in voltage between the anode 145a and the cathode 145c caused by the gaseous oxygen can be suppressed, and the cell resistance can be decreased.

Denoting a current value supplied by the power source 500 by I (ampere), the gas constant by R (L·atm/K/mol), the Faraday constant by F (c/mol), and a unit time by 1 (sec), a volume V (L/sec) of gaseous oxygen generated per unit time at 0° C. [273.15 (K)] and 1 atm is expressed by V=(I×R×273.15)/(4×F).

Furthermore, the anolyte circulator 300a circulates the anolyte at a flow rate greater than the flow rate of the catholyte circulated by the catholyte circulator 300c. Thus, the pressure inside the anode chamber 105a becomes higher than the pressure inside the cathode chamber 105c and the volume of the cathode chamber 105c decreases, and therefore uniformity of the catholyte flow increases, and the reduction current efficiency can be increased. It is preferable that a ratio of the flow rate of the anolyte to the flow rate of the catholyte be equal to or greater than 1.25 and equal to or less than 3.4. When the ratio of the flow rate of the anolyte to the flow rate of the catholyte is less than 1.25, an effect of a uniformed flow of the catholyte decreases. Further, when the ratio of the flow rate of the anolyte to the flow rate of the catholyte is greater than 3.4, the volume of the cathode chamber 105c excessively decreases, and pressure loss in circulation of the catholyte increases. The flow rate of the catholyte will be described later.

The anolyte circulator 300a includes the anode pump 310a, the anolyte supply pipe 312a, and the anolyte recovery pipe 314a. The anode pump 310a is connected to the anolyte storage tank 610a and the anolyte supply pipe 312a. The anolyte supply pipe 312a is connected to the inlet 122a on the anode frame body 120a in the electrolytic cell 100. Further, the anolyte recovery pipe 314a is connected to the outlet 124a on the anode frame body 120a in the electrolytic cell 100 and the anolyte storage tank 610a.

The catholyte circulator 300c in the circulator 300 circulates the catholyte to the cathode chamber 105c. It is preferable that the catholyte circulator 300c circulate the catholyte at a flow rate equal to or greater than six times a specific flow rate (SFR) (SFR: 6 or greater). Thus, quadrivalent or higher polyvalent vanadium contained in the catholyte is sufficiently supplied to the cathode chamber 105c, a side reaction generating hydrogen in the cathode chamber 105c can be suppressed, and the reduction current efficiency can be increased. It is preferable that the flow rate of the catholyte be equal to or less than 30 times the specific flow rate from viewpoints of increase in pressure loss, running costs, and the like.

The specific flow rate (also referred to as “stoichiometric flow rate”) means a minimum flow rate of an electrolyte theoretically required with respect to supplied current. Denoting a current value of current supplied by the power source 500 by I (ampere), the concentration of quadrivalent or higher polyvalent vanadium by C (mol/L), the Faraday constant by F (c/mol), and a unit time by 1 (sec), the specific flow rate SFR (L/sec) is expressed by SFR=I/(C×F).

The catholyte circulator 300c includes the cathode pump 310c, the catholyte supply pipe 312c, and the catholyte recovery pipe 314c. The cathode pump 310c is connected to the catholyte storage tank 610c and the catholyte supply pipe 312c. The catholyte supply pipe 312c is connected to the inlet 122c on the cathode frame body 120c in the electrolytic cell 100. Further, the catholyte recovery pipe 314c is connected to the outlet 124c on the cathode frame body 120c in the electrolytic cell 100 and the catholyte storage tank 610c.

As illustrated in FIG. 1, the power source 500 in the electrolyte manufacturing device 10 is electrically connected to the anode 145a and the base cathode 146c in the cathode 145c and supplies current. By current supplied by the power source 500, an oxidation reaction is generated in the anode chamber 105a, and a reduction reaction is generated in the cathode chamber 105c. For example, the power source 500 according to the present embodiment supplies a direct current of 50 amperes.

The anolyte storage tank 610a in the electrolyte manufacturing device 10 stores the anolyte. As illustrated in FIG. 1, the anolyte storage tank 610a is connected to the anode pump 310a and the anolyte recovery pipe 314a in the anolyte circulator 300a. The catholyte storage tank 610c in the electrolyte manufacturing device 10 stores the catholyte. The catholyte storage tank 610c is connected to the cathode pump 310c and the catholyte recovery pipe 314c in the catholyte circulator 300c.

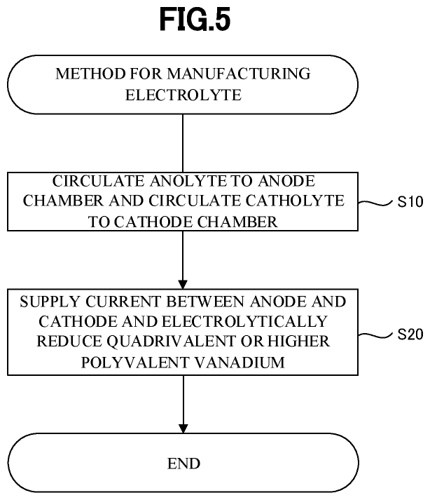

Next, a method for manufacturing an electrolyte will be described. FIG. 5 is a flowchart illustrating the method for manufacturing an electrolyte. The method for manufacturing an electrolyte includes a circulation process (Step S10) of circulating an aqueous sulfuric acid solution as the anolyte to the anode chamber 105a in the electrolytic cell 100 and circulating an aqueous sulfuric acid solution containing quadrivalent or higher polyvalent vanadium as the catholyte to the cathode chamber 105c in the electrolytic cell 100 and a reduction process (Step S20) of supplying current between the anode 145a and the cathode 145c in the electrolytic cell 100 and electrolytically reducing quadrivalent or higher polyvalent vanadium in the cathode chamber 105c in the electrolytic cell 100. As illustrated in FIG. 2, the anode 145a and the mesh-like anode net 154a placed between the anode 145a and the diaphragm 110 are placed in the anode chamber 105a separated by the diaphragm 110 in the electrolytic cell 100. Further, the cathode 145c including the carbon fiber layer 148c on a plane facing the diaphragm 110 and the mesh-like cathode net 154c placed between the cathode 145c and the diaphragm 110 are placed in the cathode chamber 105c separated by the diaphragm 110 in the electrolytic cell 100.

Returning to FIG. 5, in the circulation process (Step S10), first, an aqueous sulfuric acid solution is prepared as the anolyte, and an aqueous sulfuric acid solution containing quadrivalent or higher polyvalent vanadium is prepared as the catholyte. The aqueous sulfuric acid solution as the anolyte is adjusted to a predetermined concentration by adding sulfuric acid to pure water (at an osmol concentration equal to or greater than the osmol concentration of the catholyte). For example, the aqueous sulfuric acid solution as the catholyte containing quadrivalent or higher polyvalent vanadium is adjusted to a predetermined concentration by adding a vanadyl sulfate hydrate to pure water (1.0 mol/L to 3.0 mol/L). Then, the adjusted anolyte is supplied to the anolyte storage tank 610a illustrated in FIG. 1, and the adjusted catholyte is supplied to the catholyte storage tank 610c.

In the circulation process (Step S10), next, the anolyte stored in the anolyte storage tank 610a and the catholyte stored in the catholyte storage tank 610c are circulated to the anode chamber 105a and the cathode chamber 105c, respectively, by the circulator 300 illustrated in FIG. 1. In this case, the anolyte is circulated at a flow rate that is greater than the flow rate of the catholyte and is equal to or greater than twice the volume of gaseous oxygen generated in the anode chamber 105a per unit time at 0° C. and 1 atm.

According to the present embodiment, by making the flow rate of the anolyte greater than the flow rate of the catholyte, the pressure in the anode chamber 105a becomes higher than the pressure in the cathode chamber 105c and the volume of the cathode chamber 105c decreases, and therefore uniformity of the catholyte flow increases and the reduction current efficiency can be increased. By circulating the anolyte at a flow rate equal to or greater than twice the volume of gaseous oxygen generated in the anode chamber 105a per unit time at 0° C. and 1 atm, a rise in voltage between the anode 145a and the cathode 145c caused by the gaseous oxygen can be suppressed, and the cell resistance can be decreased. Further, since the anode net 154a secures the interval D1 between the anode 145a and the diaphragm 110, oxygen generated in the anode chamber 105a can be easily discharged, and the cell resistance can be decreased. Furthermore, since the catholyte flows inside the carbon fiber layer 148c in the cathode part 140c and through the gap secured by the cathode net 154c between the carbon fiber layer 148c and the diaphragm 110, pressure loss in circulation of the catholyte can be decreased while high reduction current efficiency achieved by the carbon fiber layer 148c is being maintained.

Returning to FIG. 5, in the reduction process (Step S20), by supplying current between the anode 145a and the cathode 145c, quadrivalent or higher polyvalent vanadium contained in the catholyte in the cathode chamber 105c is electrolytically reduced, and trivalent vanadium is generated. When an amount of quadrivalent vanadium contained in the catholyte becomes almost equivalent to an amount of trivalent vanadium, the reduction process (Step S20) is ended. Thus, an electrolyte can be manufactured.

As described above, in the electrolyte manufacturing device 10, the electrolytic cell 100 includes the anode net 154a between the anode 145a and the diaphragm 110, and therefore oxygen generated in the anode chamber 105a can be easily discharged, and the cell resistance can be decreased. Further, the electrolytic cell 100 includes the cathode net 154c between the cathode 145c including the carbon fiber layer 148c facing the diaphragm 110 and the diaphragm 110, and therefore the catholyte flows inside the carbon fiber layer 148c and through the gap secured by the cathode net 154c between the carbon fiber layer 148c and the diaphragm 110, and the electrolyte manufacturing device 10 can decrease pressure loss in circulation of the catholyte while maintaining high reduction current efficiency achieved by the carbon fiber layer 148c.

Furthermore, in the electrolyte manufacturing device 10, since the volume of the cathode chamber 105c decreases by the circulator 300 making the flow rate of the anolyte greater than the flow rate of the catholyte, flow uniformity of the catholyte increases, and the reduction current efficiency can be increased. Further, since the circulator 300 circulates the anolyte at a flow rate equal to or greater than twice the volume of gaseous oxygen generated in the anode chamber 105a per unit time at 0° C. and 1 atm, a rise in voltage caused by the gaseous oxygen between the anode 145a and the cathode 145c can be suppressed, and the cell resistance can be decreased.

While a plurality of embodiments of the present disclosure has been described above, the present disclosure is not limited to the aforementioned embodiments, and various changes and modifications may be made without departing from the spirit and scope of the present disclosure.

For example, without being limited to a platinum-coated titanium electrode, the anode 145a may be an iridium (Ir) coated titanium electrode or a platinum-iridium-coated titanium electrode. Without being limited to a lead electrode, the base cathode 146c may be a platinum-coated titanium electrode, an iridium-coated titanium electrode, or the like. From a viewpoint of uniformity of a flow rate distribution, the shape of the anode 145a and the cathode 145c (the base cathode 146c and the carbon fiber layer 148c) is preferably a rectangular parallelepiped with the length of a channel of the anolyte or the catholyte in a lengthwise direction (vertical direction) that is longer than the length of the channel of the anolyte or the catholyte in a widthwise direction.

Further, without being limited to carbon felt, the carbon fiber layer 148c has only to be an aggregate of carbon fibers.

Without being limited to polyethylene, the anode net 154a and the cathode net 154c may be formed of polypropylene, ethylene-vinyl acetate, polyvinylidene fluoride, or the like. Further, without being limited to a hexagonal mesh or a deformed rhombic mesh, the mesh of the anode net 154a and the cathode net 154c may be a rhombic mesh, a square mesh, or the like.

From viewpoints of pressure resistance, running costs, and the like of the electrolytic cell 100, it is preferable that the anolyte circulator 300a circulate the anolyte in such a way that the bubble fraction in the anode chamber 105a at 0° C. and 1 atm is equal to or greater than 5%, in other words, at a flow rate equal to or less than 20 times the volume of gaseous oxygen generated in the anode chamber per unit time at 0° C. and 1 atm.

The electrolyte manufacturing device 10 may include a plurality of electrolytic cells 100. Anode chambers 105a of the plurality of electrolytic cells 100 may be connected in series, and cathode chambers 105c may be connected in series. Further, the plurality of electrolytic cells 100 may be connected in parallel with the anolyte supply pipe 312a and the anolyte recovery pipe 314a in the anolyte circulator 300a, and the catholyte supply pipe 312c and the catholyte recovery pipe 314c in the catholyte circulator 300c.

### EXAMPLES

While the present disclosure will be described in more detail with the following Examples, the present disclosure is not limited by Examples.

In Examples, an aqueous sulfuric acid solution with a quadrivalent or higher polyvalent vanadium concentration of 1.8 mol/L was used as the anolyte in the electrolyte manufacturing device 10. An aqueous sulfuric acid solution with a sulfuric acid concentration of 4.0 mol/L was used as the catholyte in the electrolyte manufacturing device 10. SELEMION (registered trademark) CMF manufactured by AGC Inc. was used as the diaphragm 110 in the electrolytic cell 100. Further, the interval D1 between the anode 145a and the diaphragm 110 was set to 3.0 mm, and a hexagonal-mesh-like cathode net 154c having lattice pitches: p1=p2=4.5 mm, a diameter of the thread 156a: 0.9 mm, a thickness of the thread 156a at the intersection 157a: 1.7 mm illustrated in FIG. 3 was placed between the anode 145a and the diaphragm 110. Furthermore, carbon felt AAF304ZS (the thickness before being incorporated into the electrolytic cell 100: 4.3 mm) manufactured by Toyobo Co., Ltd. was used as the carbon fiber layer 148c in the cathode 145c. A deformed-rhombic-mesh-like cathode net 154c having lattice pitches: p1=7.0 mm and p2=2.9 mm, a diameter of the thread 156c: 0.25 mm, a thickness of the thread 156c at the intersection 157c: 0.63 mm illustrated in FIG. 4 was placed between the cathode 145c and the diaphragm 110. An effective area of the anode 145a and the cathode 145c was 100 cm².

In Examples, a current of 50 amperes was supplied from the power source 500, and interelectrode voltage, cathode potential, and membrane potential (liquid membrane potential) in the electrolytic cell 100 were measured. Further, inlet pressure at the inlet 122c on the cathode frame body 120c in the electrolytic cell 100 was measured as an index of pressure loss. Electric potential is based on a saturated calomel electrode.

As Comparative Examples, an electrolyte manufacturing device including an electrolytic cell acquired by excluding the cathode net 154c from the electrolytic cell 100 in Examples was prepared, and measurements were performed similarly to Examples.

### Example 1

In Example 1, the filling factor [(the thickness of the carbon fiber layer 148c before being incorporated into the electrolytic cell 100/the interval D2 between the diaphragm 110 and the base cathode 146c)×100] of the carbon fiber layer 148c was set to 86%. Further, the flow rate of the anolyte was set to 4.55 times the volume of gaseous oxygen generated in the anode chamber per unit time at 0° C. and 1 atm. Furthermore, the flow rate of the catholyte was set to 20 times the specific flow rate (the flow rate of the anolyte/the flow rate of the catholyte=2.27).

For ease of understanding, in a case where the flow rate of the anolyte is X times the volume of gaseous oxygen generated in the anode chamber per unit time at 0° C. and 1 atm, the flow rate of the anolyte is hereinafter described as a gas ratio: X. Further, in a case where the flow rate of the catholyte is Y times the specific flow rate, the flow rate of the catholyte is described as an SFR: Y. The flow rate of the anolyte/the flow rate of the catholyte is described as a flow rate ratio. In this Example, the filling factor of the carbon fiber layer 148c was 86%, the flow rate of the anolyte was a gas ratio: 4.55, the flow rate of the catholyte was an SFR: 20, and the flow rate ratio was 2.27.

### Example 2

In Example 2, the filling factor of the carbon fiber layer 148c was set to 86%. Further, the flow rate of the anolyte was set to a gas ratio: 4.55, the flow rate of the catholyte was set to an SFR: 6, and the flow rate ratio was set to 7.69.

### Comparative Example 1

In Comparative Example 1, the filling factor of the carbon fiber layer 148c was set to 86%, the flow rate of the anolyte was set to a gas ratio: 4.55, the flow rate of the catholyte was set to an SFR: 20, and the flow rate ratio was set to 2.27.

### Comparative Example 2

In Comparative Example 2, the filling factor of the carbon fiber layer 148c was set to 74%, the flow rate of the anolyte was set to a gas ratio: 4.55, the flow rate of the catholyte was set to an SFR: 15, and the flow rate ratio was set to 2.86.

### Comparative Example 3

In Comparative Example 3, the filling factor of the carbon fiber layer 148c was set to 172%, the flow rate of the anolyte was set to a gas ratio: 4.55, the flow rate of the catholyte was set to an SFR: 20, and the flow rate ratio was set to 2.13.

### Comparative Example 4

In Comparative Example 4, the filling factor of the carbon fiber layer 148c was set to 86%, the flow rate of the anolyte was set to a gas ratio: 1.25, the flow rate of the catholyte was set to an SFR: 8, and the flow rate ratio was set to 1.52.

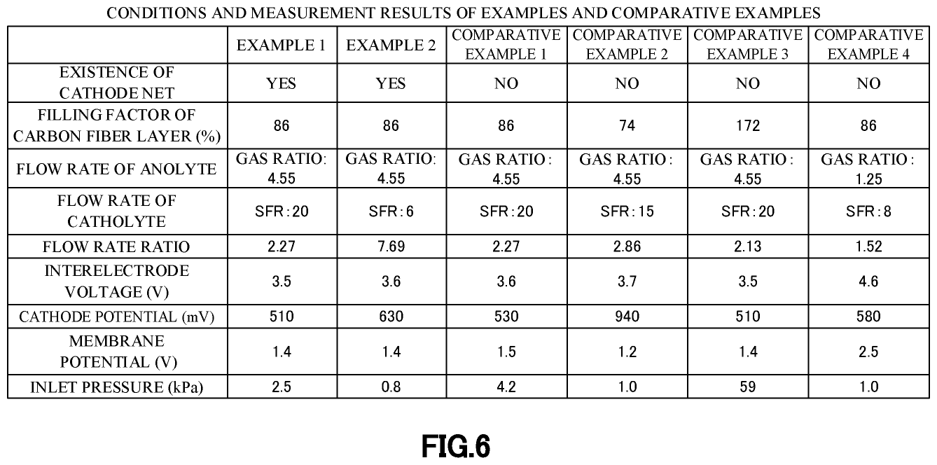

FIG. 6 illustrates measurement results of Example 1, Example 2, and Comparative Example 1 to Comparative Example 4.

As illustrated in FIG. 6, membrane potential representing the cell resistance and interelectrode voltage are low in Example 1 and Example 2, and the cell resistance in the electrolyte manufacturing device 10 in Example 1 and Example 2 is low. Further, since the cathode potential is low, the reduction current efficiency is high in the electrolyte manufacturing device 10 in Example 1 and Example 2. Furthermore, inlet pressure is lower in Example 1 relative to Comparative Example 1, and placing the cathode net 154c between the cathode 145c and the diaphragm 110 decreases pressure loss. Note that oxygen gas accumulation was observed between the anode 145a and the diaphragm 110 in Comparative Example 4.

As described above, the electrolyte manufacturing device 10 in Example 1 and Example 2 provide low cell resistance, high current efficiency in reduction, and low pressure loss in circulation of the electrolyte.

The foregoing describes some example embodiments for explanatory purposes. Although the foregoing discussion has presented specific embodiments, persons skilled in the art will recognize that changes may be made in form and detail without departing from the broader spirit and scope of the invention. Accordingly, the specification and drawings are to be regarded in an illustrative rather than a restrictive sense. This detailed description, therefore, is not to be taken in a limiting sense, and the scope of the invention is defined only by the included claims, along with the full range of equivalents to which such claims are entitled.

This application claims the benefit of Japanese Patent Application No. 2019-018747, filed on Feb. 5, 2019, the entire disclosure of which is incorporated by reference herein.

### REFERENCE SIGNS LIST

10 Electrolyte manufacturing device
100 Electrolytic cell
105a Anode chamber
105c Cathode chamber
110 Diaphragm
120a Anode frame body
120c Cathode frame body
122a, 122c Inlet
124a, 124c Outlet
140a Anode part
142a Anode base plate
143a Recessed part
145a Anode
140c Cathode part
142c Cathode base plate
143c Recessed part
145c Cathode
146c Base cathode
148c Carbon fiber layer
150a Anode net part
152a Frame part
154a Anode net
156a, 156c Thread
157a, 157c Intersection
150c Cathode net part
152c Frame part
154c Cathode net
300 Circulator
300a Anolyte circulator
310a Anode pump
312a Anolyte supply pipe
314a Anolyte recovery pipe
300c Catholyte circulator
310c Cathode pump
312c Catholyte supply pipe
314c Catholyte recovery pipe
500 Power source
610a Anolyte storage tank
610c Catholyte storage tank
D1 Interval between anode and diaphragm
D2 Interval between diaphragm and base cathode
p1, p2 Pitch

1. An electrolyte manufacturing device comprising:
an electrolytic cell including an anode chamber in which an anode is placed, a cathode chamber in which a cathode is placed, and a diaphragm separating the anode chamber from the cathode chamber;
a circulator circulating an aqueous sulfuric acid solution as an anolyte to the anode chamber and circulating an aqueous sulfuric acid solution containing quadrivalent or higher polyvalent vanadium as a catholyte to the cathode chamber; and
a power source being electrically connected to the anode and the cathode and supplying current,
wherein
the cathode includes a carbon fiber layer on a plane facing the diaphragm,
the electrolytic cell includes a mesh-like anode net placed between the anode and the diaphragm, and a mesh-like cathode net placed between the cathode and the diaphragm, and
the circulator circulates the anolyte at a flow rate that is greater than a flow rate of the catholyte and is equal to or greater than twice a volume of gaseous oxygen generated in the anode chamber per unit time at 0° C.

2. The electrolyte manufacturing device according to claim 1, wherein a ratio of a flow rate of the anolyte to a flow rate of the catholyte is equal to or greater than 1.25 and equal to or less than 3.4.

3. The electrolyte manufacturing device according to claim 1, wherein a filling factor of the carbon fiber layer is equal to or greater than 70% and equal to or less than 120%.

4. The electrolyte manufacturing device according to claim 1, wherein the circulator circulates the catholyte at a flow rate equal to or greater than six times a specific flow rate.

5. The electrolyte manufacturing device according to claim 1, wherein concentration of the quadrivalent or higher polyvalent vanadium in an aqueous sulfuric acid solution containing the quadrivalent or higher polyvalent vanadium is equal to or greater than 1.0 mol/L and equal to or less than 3.0 mol/L.

6. The electrolyte manufacturing device according to claim 1, wherein a thickness of the cathode net is less than a thickness of the anode net.

7. A method for manufacturing an electrolyte comprising:
a circulation process of circulating an aqueous sulfuric acid solution as an anolyte to an anode chamber separated by a diaphragm, an anode and a mesh-like anode net placed between the anode and the diaphragm being placed in the anode chamber, and circulating an aqueous sulfuric acid solution containing quadrivalent or higher polyvalent vanadium as a catholyte to a cathode chamber separated by the diaphragm, a cathode including a carbon fiber layer on a plane facing the diaphragm, and a mesh-like cathode net placed between the cathode and the diaphragm being placed in the cathode chamber; and
a reduction process of supplying current between the anode and the cathode and electrolytically reducing the quadrivalent or higher polyvalent vanadium in the cathode chamber,
wherein, in the circulation process, the anolyte is circulated at a flow rate that is greater than a flow rate of the catholyte and is equal to or greater than twice a volume of gaseous oxygen generated in the anode chamber per unit time at 0° C.

8. The method for manufacturing an electrolyte according to claim 7, wherein, in the circulation process, the anolyte is circulated at a flow rate ratio equal to or greater than 1.25 and equal to or less than 3.4 relative to the catholyte.

9. The method for manufacturing an electrolyte according to claim 7, wherein, in the circulation process, the catholyte is circulated at a flow rate equal to or greater than six times a specific flow rate.
